(19) United States
(12) Patent Application Publication
(10) Pub. No.: US 2019/0295118 A1
(43) Pub. Date: Sep. 26, 2019

(54) INTERACTIVE GRAPHICAL USER INTERFACE FOR GENERATION AND MANAGEMENT OF USER INCENTIVES

(71) Applicant: Family Dollar IP Co., LLC, Matthews, NC (US)

(72) Inventors: Matthew Aaron Martin, Weddington, NC (US); Sarah Dellinger Ferguson, Indian Trail, NC (US)

(73) Assignee: Family Dollar IP Co., LLC, Matthews, NC (US)

(21) Appl. No.: 16/359,894

(22) Filed: Mar. 20, 2019

Related U.S. Application Data
(60) Provisional application No. 62/645,625, filed on Mar. 20, 2018.

(51) Int. Cl. G06Q 30/02; G06F 3/0484

(52) U.S. Cl. CPC G06Q 30/0236; G06F 3/04847; G06Q 30/0209; G06Q 30/0239

(57) ABSTRACT

An enhanced incentive management interface is provided wherein a mobile device executes computer-readable program code and is configured to cause the at least one processing device to receive notification information from an incentive management system, wherein the notification information indicates a user's eligibility to acquire an incentive, display the notification information on the at least one display device, receive, from the incentive management system, user-eligible incentives, display a selectable interactive element on the at least one display device, and in response to the user selecting the interactive element, display, on the at least one display device, an acquired incentive, wherein the acquired incentive is one of the user-eligible incentives.

### PRIORITY CLAIM

This application claims priority to U.S. Provisional Application Ser. No. 62/645,625, filed Mar. 20, 2018, entitled INTERACTIVE SYSTEM FOR GENERATION AND MANAGEMENT OF USER INCENTIVES, which is incorporated herein by reference in its entirety.

### FIELD OF THE INVENTION

The present invention is generally directed to incentive generation and management and, more specifically, a system that provides for dynamic incentive generation and management interface with capabilities for analyzing and processing user profile information and various other information from a user mobile device. The user mobile device is configured to receive notification information from an incentive management system, wherein the notification information indicates a user's eligibility to acquire an incentive, display the notification information on the at least one display device, receive, from the incentive management system, user-eligible incentives, display a selectable interactive element on the at least one display device, and in response to the user selecting the interactive element, display, on the at least one display device, an acquired incentive, wherein the acquired incentive is one of the user-eligible incentives.

### BACKGROUND

There are currently systems designed for incentive generation, management and disbursement. There is a need for an improved system structured for incentive generation and management such that incentives are created in response to specific user attributes or activities, such as user locations and past/present user activities.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address these and/or other needs by providing an enhanced incentive management platform configured for intelligent, proactive and responsive integration of additional incentive generation with an interactive incentive application provided on a user device. The system is further configured to present opportunities for additional incentive generation to the user by linking user profile data intelligently and removing the need for the customer to initiate or request incentive generation by providing the system with qualifying information. Furthermore, the system is configured to receive input about the user through multiple communication channels and devices. The system is configured to switch between the various communication channels seamlessly, and in real-time. Various notifications may be transmitted to users by the system via multiple user devices, and the users may interact with the system through an incentive management application on such devices. The incentive management application is designed to include incentive activities or games that present the user with opportunities to accrue incentives subject to a number of parameters.

Embodiments of the invention relate to systems, methods, and computer program products for incentive generation and management and responsive communication with a user, the invention generally comprising: providing a mobile application to a mobile device of a user, wherein the mobile application is configured to cause the mobile device to: receive notification information from the incentive management system for display on a mobile device; display the notification information on the mobile device; receive identified user eligible incentives; display a selectable interactive element on the mobile device; and based on the user selecting the interactive element, display an acquired incentive, wherein the acquired incentive is one of the user-eligible incentives; receiving a request from the user to enroll in the incentive management system; receiving user profile information from the user; generating and storing a user profile containing the user profile information; based on the user profile information, identifying user-eligible incentives; and generating and transmitting, to the mobile device, the notification information, wherein the notification information indicates an option for the user to acquire one of the user-eligible incentives.

In some embodiments, invention is configured to receive a request from the mobile device for details of the acquired incentive; and transmit, to the mobile device, details of the acquired incentive as a barcode, quick response (QR) code, or alphanumerical code.

In some embodiments, invention is configured to at least partially randomly select an acquired incentive from the user-eligible incentives; store the acquired incentive in the user profile; and transmit the acquired incentive to the mobile device.

In some embodiments, invention is configured to receive, from the mobile device, the acquired incentive selected by the mobile device and store the acquired incentive in the user profile.

In some embodiments, the identified user-eligible incentives are generated based on weighted user profile information.

In some embodiments, the provided mobile application is configured to cause the mobile device to the determine a location of the mobile device and transmit the location to the incentive management system.

In some embodiments, invention is configured to receive the location information from the mobile device; and analyze the location information to determine that the mobile device's location is proximate to an entity location; wherein the notification information is transmitted to the mobile device in response to determining that the mobile device's location is proximate the entity location.

In some embodiments, invention is configured to receive additional user profile information; and based on the additional user profile information, alter the user-eligible incentives based on the additional user profile information.

In some embodiments, the invention is configured to receive third party incentives from a third party incentive management system; and incorporate the third party incentives in the identified incentives that the user is eligible to acquire.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 depicts an incentive management platform with integrated incentive activity features environment, in accordance with one embodiment of the present invention;

FIG. 2 depicts an incentive relevancy engine 202 and incentive management engine 210 within a communication environment 200, in accordance with one embodiment of the present invention;

FIG. 3 depicts a high level process flow for interactive incentive generation and management. As shown in block 300, the process by enrolling a user in the incentive management system 106;

FIG. 4 depicts an interaction environment, in accordance with one embodiment of the present invention;

FIG. 5 depicts a representation of one embodiment of the present invention as implemented on a user device;

FIG. 6 depicts an incentive management platform with incentive relevancy engine and communication environment 600, in accordance with one embodiment of the present invention;

FIG. 7 depicts an exemplary incentive management application on a user device in accordance with an exemplary embodiment of the present invention as implemented on a user device; and

FIG. 8 depicts an exemplary incentive management application on a user device in accordance with an exemplary embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.”

In some embodiments, an “entity” or “enterprise” as used herein may be any institution or establishment, associated with a network connected user profile platform, purchase platform, or patron platform. As such, the entity may be any institution, group, association, merchant, establishment, company, union, authority or the like. In some embodiments, the entity represents a vendor or a merchant with whom a user engages in financial (for example, resource transfers like purchases, payments, returns, enrolling in merchant accounts and the like) or non-financial transactions (for resource transfers associated with loyalty programs and the like), either online or in physical stores.

As described herein, a “user” is an individual associated with an entity. As such, in some embodiments, the user may be an individual having past relationships, current relationships or potential future relationships with an entity. In typical embodiments, a “user” is any individual or entity who has a relationship with the entity, such as a customer or a prospective customer. For purposes of this invention, the term “user” and “customer” may be used interchangeably. In some embodiments, a “user” may be an employee (e.g., an associate, a project manager, an IT specialist, a manager, an administrator, an internal operations analyst, or the like) of the entity or enterprises affiliated with the entity, capable of operating the systems described herein.

In some embodiments, the entity may provide one or more technology instruments to the user for use in resource transfer activities or transactions. In some embodiments, the technology instruments like electronic tokens, coupons, loyalty cards, entity user device applications, account identifiers, passcodes and the like are associated with one or more resources or accounts of the user or customer.

As used herein, a “user interface” may be a graphical user interface. Typically, a graphical user interface (GUI) is a type of interface that allows users to interact with electronic devices such as graphical icons and visual indicators such as secondary notation, as opposed to using only text via the command line. That said, the graphical user interfaces are typically configured for audio, visual and/or textual communication. In some embodiments, the graphical user interface may include both graphical elements and text elements. The graphical user interface may be configured to be presented on one or more display devices associated with user devices 104, entity systems 160, auxiliary user devices 170, processing systems and the like.

A resource activity, also referred to as a technology activity, such as a “resource transfer” or “transaction”, may refer to any electronic activities or communication between a user or entity, between the user and the entity, activities or communication between multiple entities, between users, between technology applications and the like. A resource transfer may refer to a payment, processing of funds, purchase of goods or services, a return of goods or services, a payment transaction, a credit transaction, or other interactions involving a user's resource or account. In the context of an entity such as a merchant, a resource transfer may refer to one or more of: a sale of goods and/or services, a rewards transfer, opening an application on a user's computer or mobile device, a user accessing their e-wallet, or any other interaction involving the user and/or the user's device that invokes or is detectable by the entity. A resource transfer may include one or more of the following: renting, selling, and/or leasing goods and/or services (e.g., groceries, stamps, tickets, DVDs, vending machine items, and the like); making payments to creditors (e.g., paying monthly bills; paying federal, state, and/or local taxes; and the like); sending remittances; loading money onto stored value cards (SVCs) and/or prepaid cards; donating to charities; and/or the like. Unless specifically limited by the context, a “resource transfer” a “transaction”, “transaction event” or “point of transaction event” refers to any activity initiated between a user and an entity such as a merchant. In some embodiments, a resource transfer or transaction may refer to financial transactions involving direct or indirect movement of funds through traditional paper transaction processing systems (i.e. paper check processing) or through electronic transaction processing systems. In this regard, resource transfers or transactions may refer to the user initiating a purchase for a product, service, or the like from a merchant. Typical financial transactions include point of sale (POS) transactions, person-to-person (P2P) transfers, internet transactions, online shopping, electronic funds transfers between accounts, and conducting purchases using loyalty/rewards points etc. In some embodiments, a resource transfer or transaction may refer to non-financial activities of the user. In this regard, the transaction may be a customer account event, such as but not limited to the customer changing a password, adding new accounts, adding or modifying account parameters/restrictions, performing/modifying authentication procedures, and the like.

The user may utilize an external apparatus such as a user device, for executing resource transfers or transactions. The external apparatus may be a user device (computing devices, mobile devices, wearable devices, and the like), a payment instrument (credit cards, debit cards, checks, digital wallets, currency, loyalty points), and/or payment credentials (account numbers, payment instrument identifiers). In some embodiments, the user may perform transactions by swiping payment instruments at a transaction terminal, for example, by swiping a magnetic strip of a credit card along a magnetic reader of a transaction terminal. In some embodiments, the transactions may be performed by wireless communication or “tapping” between the customer device and a transaction terminal. In accordance with some embodiments of the invention, the term “tap” or “tapping” may refer to bringing an external apparatus close to or within a predetermined proximity of the activity interface device or transaction terminal interface, or auxiliary user devices 170, so that information (such as encrypted tokens, financial resource/account identifiers, and the like) can be communicated wirelessly between the external apparatus and the devices using short range wireless transmission technology, such near-field communication (NFC) technology, radio-frequency (RF) technology, audio-frequency communication, or the like. Tapping may include physically tapping the user device against an appropriate portion of the auxiliary user device 170 or the transaction terminal or it may include only waving or holding the user device near an appropriate portion of the auxiliary user device 170 or the transaction terminal without making physical contact with the transaction terminal.

In accordance with embodiments of the invention, the term “incentive” may refer to a discount, offer, coupon, currency, electronic token, promotion or the like that may be used or redeemed at an entity, merchant or other third party location. The incentive may be delivered in a physical manner, such as a gift card or physical coupon, or delivered in an electronic manner such as providing a code to a user through the use of an electronic communication or display via an application on a user device. Instead of or in addition to electronic or physical delivery, the incentive may be applied to a user profile or associated with a user account such that the incentive may be applied to a current or future purchase upon system recognition that a particular user account is associated with a resource transfer activity. Furthermore, the incentive may be generated and issued by the entity where the incentive is intended to be applied, or the incentive may be generated and issued by a third party entity for later use by a user or customer at one or more entities.

The present invention is directed to, in general, a system for generation and management of user incentives comprising a network-connected incentive management platform and use of a network connected incentive management application. Furthermore, the present invention is configured to integrate interaction tracking technology and functionality into an incentive management application of a user device, proactively and in real-time, and provide an interactive incentive activity or game to users in order encourage participation. This system is further characterized as an intelligent, proactive and responsive system that facilitates and promotes user awareness and incentive management to generate and continuously update incentives based on user-specific parameters.

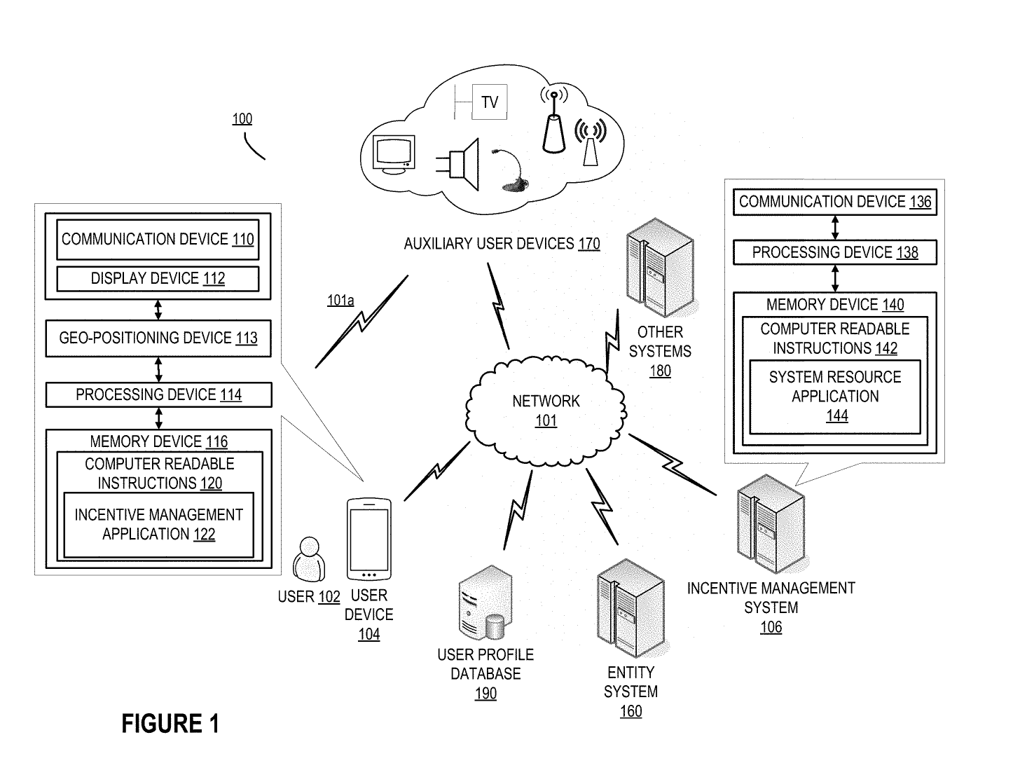

FIG. 1 illustrates enhanced incentive management platform environment 100 in accordance with one embodiment of the present invention. As illustrated in FIG. 1, an incentive management system 106 is configured for providing an intelligent, proactive and responsive application or system to the user device 104 and facilitate execution of incentive management activities in an integrated manner. The incentive management system is operatively coupled, via a network 101 to one or more user devices 104, auxiliary user devices 170, to entity systems 160, user profile database 190, other systems 180 and other external systems/third-party servers not illustrated herein. The user profile database 190 may include one or more storage databases for storage of information used by the incentive management system 106. Information included in the user profile database 190 may include such data about a number of users and incentives that they may be eligible for or may have acquired. In addition, the use profile database 190 may include user account information, user transaction data, user location data, user demographic data, and metadata associated with the user's activities and interactions with the incentive management system 106 or other systems 180. Other systems 180 may include additional storage systems, such as a database managed by a third party, or a wallet system configured to interface with one or more systems and track the user's incentives, payment credentials, accounts, and payment instruments. Other systems 180 may also include point of sale systems, or third party incentive systems that might exchange data with the incentive management system 106. In this way, the incentive management system 106 can send information to and receive information from the user device 104 as well as a number of other storage systems and entities to provide an integrated platform with multi-channel resource management capabilities to a user 102, and particularly to the user device 104. Moreover, it is understood that the system may interact with multiple user devices that may be substantially similar in structure and/or function.

At least a portion of the incentive management platform with integrated resource activity features is typically configured to reside on the user device 104 (for example, at the incentive management application 122), on the system 106 (for example, at the system resource application 144), and/or on other devices and system and is an intelligent, proactive, responsive system that facilitates execution of incentive production and application in a manner that integrates with concurrent or future user purchase activity. Furthermore, the incentive management platform is typically capable of seamlessly integrating user-specific and/or resource specific functionality into an interface of the incentive management application 122 and may be customizable by the system 106 and/or the user 102.

The network 101 may be a global area network (GAN), such as the Internet, a wide area network (WAN), a local area network (LAN), or any other type of network or combination of networks. The network 101 may provide for wireline, wireless, or a combination wireline and wireless communication between devices on the network 101. The network 101 is configured to establish an operative connection between devices, for example establishing a communication channel, automatically and in real time, between the one or more user devices 104 and one or more of the auxiliary user devices 170, (for example, based on reeving a user input, or when the user device 104 is within a predetermined proximity or broadcast range of the auxiliary devices 170). Therefore, the system, via the network 101 may establish, operative connections between otherwise incompatible devices, for example by establishing a communication channel 101a between the one or more user devices 104 and the auxiliary user devices 170. In this regard, the network 101 (and particularly the communication channels 101a) may take the form of contactless interfaces, short range wireless transmission technology, such near-field communication (NFC) technology, Bluetooth® low energy (BLE) communication, audio frequency (AF) waves, wireless personal area network, radio-frequency (RF) technology, and/or other suitable communication channels. Tapping may include physically tapping the external apparatus, such as the user device 104, against an appropriate portion of the auxiliary user device 170 or it may include only waving or holding the external apparatus near an appropriate portion of the auxiliary user device without making physical contact with the auxiliary user device.

In some embodiments, the user 102 is an individual that wishes to conduct one or more activities associated with a merchant or entity, etc., for example using the user device 104 (e.g., associated user node) to verify their presence and initiate the use of an incentive during a transaction. In some embodiments, the user 102 may access the incentive management system 106 and/or the entity system 160 through a user interface of the user device 104 where such user interface is in the form of a webpage and/or a mobile application.

Hereinafter, “mobile application n” is used to refer to an application on the user device 104 of the user 102, a widget, a webpage accessed through a browser, and the like. In some embodiments the mobile application is an incentive management application 122, sometimes referred to as a mobile application or mobile application interface herein, stored on the user device 104. In some embodiments the incentive management application 122 may refer to a third party application or mobile application stored on a cloud used to access the incentive management system 106 and/or the auxiliary user device 170 through the network 101, communicate with or receive and interpret signals from auxiliary user devices 170, and the like. In some embodiments, the mobile application n is stored on the memory device 140 of the incentive management system 106, and the user interface is presented on a display device of the user device 104, while in other embodiments, the mobile application is stored on the user device 104. The user 102 may subsequently navigate through the interface, perform one or more searches or initiate one or more interactive incentive activities using a central user interface provided by the incentive management application 122 of the user device 104. In some embodiments, the user 102 may be routed to a particular destination using the user device 104. In some embodiments, a purchase may be made by the user 102 using the user device 104. In some embodiments the auxiliary user device 170 requests and/or receives additional information from the incentive management system 106/the entity system 160 and/or the user device 104 for authenticating the user and/or the user device, determining appropriate transaction queues, performing the transactions and other functions.

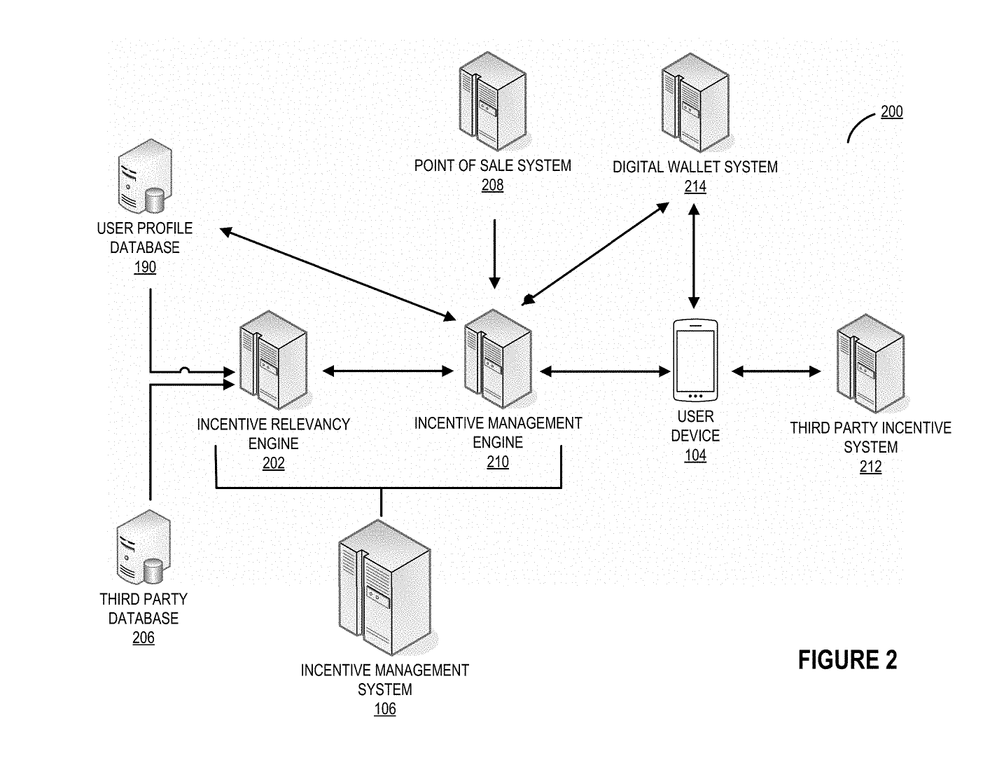

FIG. 1 also illustrates the user device 104. The user device 104, herein referring to one or more user devices, may generally comprise a communication device 110, a display device 112, a geo-positioning device 113, a processing device 114, and a memory device 116. The user device 104 is a computing system that allows a user 102 to interact with other systems to initiate or to complete activities, resource transfers, and transactions for products, and the like. The processing device 114 is operatively coupled to the communication device 110 and the memory device 116. The processing device 114 uses the communication device 110 to communicate with the network 101 and other devices on the network 101, such as, but not limited to the auxiliary user devices 170 and the incentive management system 106. As such, the communication device 110 generally comprises a modem, server, or other device for communicating with other devices on the network 101. In some embodiments the network 101 comprises a network of distributed servers. In some embodiments, the processing device 114 may be further coupled to a display device 112, a geo-positioning device 113, and/or a transmitter/receiver device, not indicated in FIG. 2. The display device 112 may comprise a screen, a speaker, a vibrating device or other devices configured to provide information to the user. In some embodiments, the display device 112 provides a presentation of the central user interface of the incentive management application 122. The geo-positioning device 113 may comprise global positioning system (GPS) devices, triangulation devices, accelerometers, and other devices configured to determine the current geographic location of the user device 104 with respect to satellites, transmitter/beacon devices, telecommunication towers and the like. In some embodiments the user device 104 may include authentication devices like fingerprint scanners, heart-rate monitors, microphones and the like that are configured to receive bio-metric authentication credentials from the user.

The user device 104 comprises computer-readable instructions 120 stored in the memory device 116, which in one embodiment includes the computer-readable instructions 120 of the incentive management application 122. In this way, users 102 may authenticate themselves, initiate activities, and interact with or receive and decode signals from the auxiliary user devices 170, communicate with the incentive management system 106, authorize a transaction, and/or complete a transaction using the central user interface of the user device 104. As discussed previously, the user device 104 may be, for example, a desktop personal computer, a mobile device, such as a cellular phone, smart phone, personal data assistant (PDA), laptop, wearable device, a smart TV, a smart speaker, a home automation hub, augmented/virtual reality devices, or the like. The computer readable instructions 120, when executed by the processing device 114 are configured to cause the user device 104 and/or processing device 114 to perform one or more steps described in this disclosure, or to cause other systems/devices to perform one or more steps described herein.

The incentive management system 106 and incentive management application 122 are configured to present an integrated central user interface for communicating with the user, for execution of one or more user activities such as incentive acquisition and allocation, communicating and performing associated incentive activities and functions without requiring the user to access the multiple applications. As such, the incentive management application 122 is configured to perform one or more user resource sharing/allocation and associated activities in a convenient, proactive and timely manner. In this regard, in some embodiments, the central user interface is presented on one or more user devices via the incentive management application 122 or the incentive management application 122. The interface associated with the incentive management application 122 may be presented on the display device 112 of the user device 104 in response to receiving an indication from the user (for example, receiving a voice command from the user with an identifier associated with the incentive management application 122, receiving a tactile indication or a fingerprint authentication form a home button of the user device 104, and the like). The interface of the incentive management application may, in some embodiments, react automatically in response to detecting an action trigger (for example, determining that the user is attempting to perform a user activity by using a particular application, determining that the user is present at a certain entity location, determining that a user has met some threshold for eligibility of additional incentives), and the like.

As further illustrated in FIG. 1, the incentive management system 106 generally comprises a communication device 136, at least one processing device 138, and a memory device 140. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 138 is operatively coupled to the communication device 136 and the memory device 140. The processing device 138 uses the communication device 136 to communicate with the network 101 and other devices on the network 101, such as, but not limited to auxiliary user devices 170 and/or the user device 104. As such, the communication device 136 generally comprises a modem, server, wireless transmitters or other devices for communicating with devices on the network 101.

As further illustrated in FIG. 1, the incentive management system 106 comprises computer-readable instructions 142 stored in the memory device 140, which in one embodiment includes the computer-readable instructions 142 of a system resource application 144 (also referred to as a “system application”). The computer readable instructions 142, when executed by the processing device 138 are configured to cause the incentive management system 106/processing device 138 to perform one or more steps described in this disclosure to cause out systems/devices to perform one or more steps described herein. In some embodiments, the memory device 140 includes a data storage for storing data related to user transactions and entity information, but not limited to data created and/or used by the system resource application 144.

FIG. 1, further illustrates one or more auxiliary user devices 170, in communication with the network 101. The auxiliary user devices 170 may include point of sale systems, devices managed by third parties, or devices such as smart watches, speakers, microphones, smart speakers, display devices, a desktop personal computer, a mobile system, such as a cellular phone, smart phone, personal data assistant (PDA), laptop, wearable device, a smart TV, a smart speaker, a home automation hub, augmented/virtual reality devices, or the like. In some embodiments, the auxiliary user devices 170 may be used to communicate with the incentive management system 106 to receive notifications, transmit updated profile information, confirm or authenticate user identity, or transmit a number of other data forms that may be relevant to the user's location, interests, demographic information, and eligible incentives, or acquired incentives.

As described throughout much of this specification, a “system” is generally used to describe a device or group of interconnected or networked devices for performing one or more steps described herein. In some cases, the “system” may be a shorthand reference to the incentive management system 106, or a combination of the incentive management system and 106 and the incentive management application 122 working together to receive information from and provide information to the user 102, and other systems 180.

FIG. 2 depicts an incentive relevancy engine 202 and incentive management engine 210 within a communication environment 200, in accordance with one embodiment of the present invention. The incentive relevancy engine 202 and the incentive management engine 210 are each sub-systems of the incentive management system 106, and each work in conjunction with one another to provide incentives to the user device 104. As illustrated in FIG. 2, the incentive relevancy engine 202 is situated to receive user-related data from a user profile database 190 and information from a third party database 206. In some embodiments, there may be multiple third party databases interacting with the incentive relevancy engine 202. The incentive relevancy engine 202 is designed to receive and process data from various sources to determine relevant incentives, offers, and content for each particular user or group of users that interacts with the incentive management system. In addition, by analyzing data from the user profile database 190 and instructions, such as metrics, thresholds, and quotas, from the incentive management engine 201, the incentive relevancy engine 202 may determine which incentives a particular use is eligible to acquire. In some embodiments, the incentive relevancy engine 202 may determine that a set of incentives are relevant to the particular user, and may randomly select a subgroup of relevant incentives to determine user-eligible incentives. In other embodiments, the incentive relevancy engine 202 may determine a subgroup of the user-eligible incentives that the user is able to acquire, which in some cases may also be a random determination. In some embodiments, the incentive relevancy engine 202 is managed by the same entity that maintains the incentive management system 106, while in other embodiments the incentive relevancy engine is managed by a third party entity.

The incentive relevancy engine 202 may determine resource activities associated with incentives for the user 102 that are likely required or preferred by the user 102 (e.g., using a ranking system based on the number/frequency of data points associated with past users) for current or future transactions at a given entity. For example, the system may determine, based on user profile information, that the user 102 in the process of renovating a home would be seeking to buy painting materials and identify a particular incentive related to a discount on such materials. As another example, the system may determine that the user likely has children and may be interested in pool toys during the summer months. Here, based on past user data associated with past users who also stayed in similar cities/ locations, the system may determine incentives that users are mostly likely to utilize. The system may present the user with an opportunity to rate incentives based on relevancy, and may store this data in the user's profile to further tailor future incentives based on the user's ranking, actual utilization of the incentive, or failure to utilize the incentive.

As further illustrated in FIG. 2, incentive management engine 210 is situated to interact with incentive relevancy engine 202, user profile database 190, point of sale system 208, and user device 104. In some embodiments, incentive relevancy engine 202 and incentive management engine 210 are both considered a part of the incentive management system 106. In some embodiments, the incentive management engine 210 is managed by the same entity that maintains the incentive management system 106 and/or incentive relevancy engine 202, while in other embodiments the incentive management engine 210 is managed by a third party entity. The incentive management engine is designed to interface with a point of sale system 208, which in some embodiments may be a part of entity system 160, other systems 180, or may be considered an auxiliary user device 170. Various data about a current, past, or future transactions may be considered and utilized by the incentive management system, and may be received from the point of sale system 208, user device 104, entity system 160, or other systems 180. Transaction data may be collected in real time and communicated to the user profile database 190, incentive relevancy engine 202, and may be reflected in information transmitted from the incentive management engine 210 to the user device 104. Transaction data, and metadata associated with transaction data, may be used by the incentive relevancy engine 202 to determine incentives relevant to the user 102. In some embodiments, the incentive management engine 210 is responsible for transmitting data to the user device 104 to update the information displayed to the user 102 through the incentive management application 122. Data from other sources may also be incorporated into the incentive management application 122, such as from a digital wallet system 214 or some other system, such as third party incentive system 212.

As further shown in FIG. 2, the digital wallet system 214 may interact with the incentive management engine 210 and user device 104. In some embodiments, the digital wallet system 214 is managed by the same entity that maintains the incentive management system 106 and/or incentive relevancy engine 202, and thus may be located on entity system 160, while in other embodiments the digital wallet system 214 is managed by a third party entity and thus be located on other systems 180. In some embodiments, the digital wallet system 214 may be integrated within the incentive management application 122 or user profile database 190 in order to store and track usage of user acquired incentives, or to provide secure storage and utilization of payment credentials or tokens/aliases associated with a digital wallet, or account identifiers for the user 102. In this way, the incentives generated by the incentive management system may integrate information provided by the digital wallet system 214 in order to provide a single location for the user to access various incentives and account information. Furthermore, as shown in FIG. 2, communication environment 200 may also include third party incentive system 212. In some embodiments, the third party incentive system may be utilized by the entity in the production and management of incentives. For instance, in some embodiments, the user may be given an opportunity to acquire incentive offers within the incentive management application 122, wherein the details and validity timeframe of the incentive offer might be managed by the third party incentive system 212.

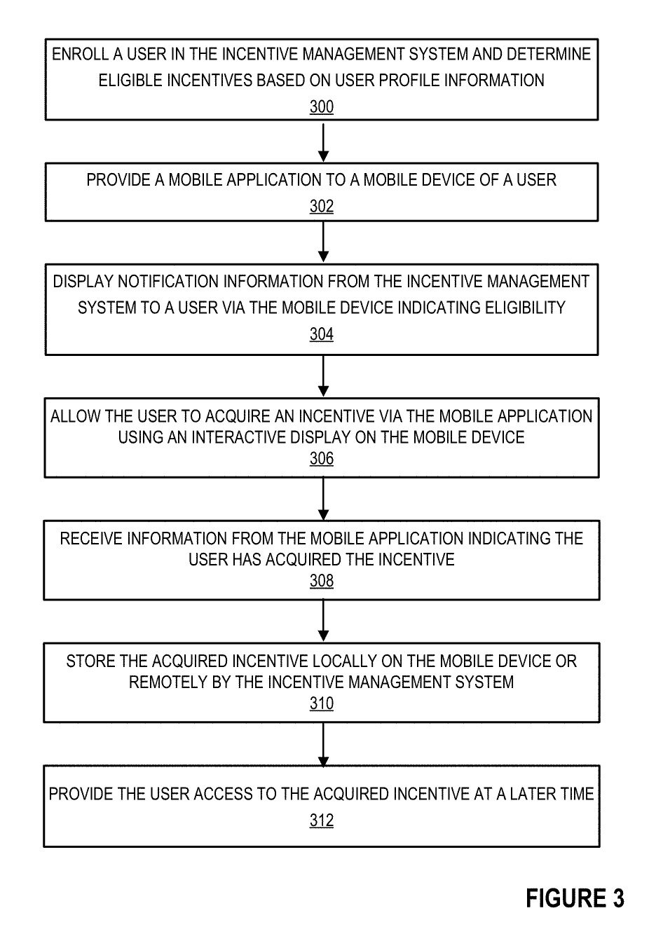

FIG. 3 depicts a high level process flow for interactive incentive generation and management. As shown in block 300, the process by enrolling a user in the incentive management system 106. This includes creating and storing a user profile for the user, which is stored on the user profile database 190. In some embodiments, the user may request enrollment through the user device 104, the point of sale system 208, or some other auxiliary user device 170. Based on the information contained in the user profile, the incentive management system 106 determines, using the incentive relevancy engine 202 and instructions from the incentive management engine 210, certain incentives for which the user is eligible, or user-eligible incentives. As discussed previously, the user-eligible incentives may be based on a number of factors related to the user's profile information, including their transaction history, interests, location, demographics, and the like. The user-eligible incentives may also vary based on the length of time the user profile has been established, how often the user visits a certain location, or the user's affiliation with a certain entity. In some embodiments, certain profile characteristics are given specific weights in the determination of user-eligible incentives. In some embodiments, certain user profile characteristics may be seen as indicating a user's loyalty to the entity managing the incenting management system 106, and these certain loyalty characteristics may be given a greater weight, or may be directly linked to eligibility for certain incentives or sets of incentives for which the user may be deemed eligible. After the system establishes a user profile for the user 102, it may then link the user profile with an existing account profile associated with any given entity. For example, the user 102 may enroll in the incentive management system 106 using their email address, which is automatically identified as being associated with an existing loyalty profile at one or more other entities. In this way, the system may receive information from the other entities about user activity associated with the other entities, such as transaction history, transaction frequency, demographic information, and the like, and use this information to populate the user profile on the user profile database.

In some embodiments, the user 102 may be given the ability to create a password upon registration, which is then stored in the user profile database 190 for authorizing use of the incentive management application 122 on the user device. In some embodiments, the password is only required periodically after a given time period, while in other embodiments the user 102 may set a preference to store the user password and remain logged in indefinitely. In still further embodiments, the password may only be required to redeem acquired incentives generated by the system and stored in the user's profile or to make changes to user preferences. Use of various authorization methods associated with the user device 104 itself are also contemplated, including biometric authorization of the user based on any number of parameters, including but not limited to fingerprint recognition, facial recognition, voice recognition, speech pattern recognition, retina scanning, and the like.

The user profile may also contain information pertaining to auxiliary user devices 170 that the user may employ to interact with the incentive management system 106. For example, the user 102 may indicate that the user 102 wears a smart watch. The system is designed to operate in conjunction with such auxiliary user devices 170 and display of information on the auxiliary user devices 170, including notifications, incentive redemption, eligibility and acquisition information, or any other information that may aid the user during their utilization of the incentive management system 106.

Next, as shown by block 302, the incentive management platform may provide a mobile application to a mobile device of the user, such as incentive management application 122. The mobile application may interact with the incentive management system 122 in order to receive and display notifications, display an interactive interface for the user, and allow the user to interact with the incentive management system to acquire incentives and access stored incentives that the user has already acquired. The user may also transmit updated user profile information, location information, and preferences through the incentive management application 122 on the user device 104 that the incentive management system receives and stores in the user profile database 190. As shown in block 204, the mobile application may be designed to display an alert of notification information provided from the incentive management system 106. The alert of notification information provided for the incentive management system 106 and displayed on the user device 104 may be prompted in response to some change in user profile information, or may be prompted upon determining, based on location information, transaction information, or some other data received from the user device 104. In some embodiments, the incentive management system 106 may receive location information from the user device 104 and determine that the location of the user device 104 is proximate to an entity location or some other notable location, and may provide the display notification to the user device based on making this determination. Similarly, the incentive management system 106 may receive transaction information from the user device 104, other system 180, point of sale system 208, or digital wallet system 214, and may provide the display notification to the user device based on determining, based on the received transaction information, that the user 102 has completed a transaction. In some embodiments, the notification may be promoted by further analyzing metadata associated with the transaction information to determine a certain spend amount, certain product that the user has purchased, and the like.

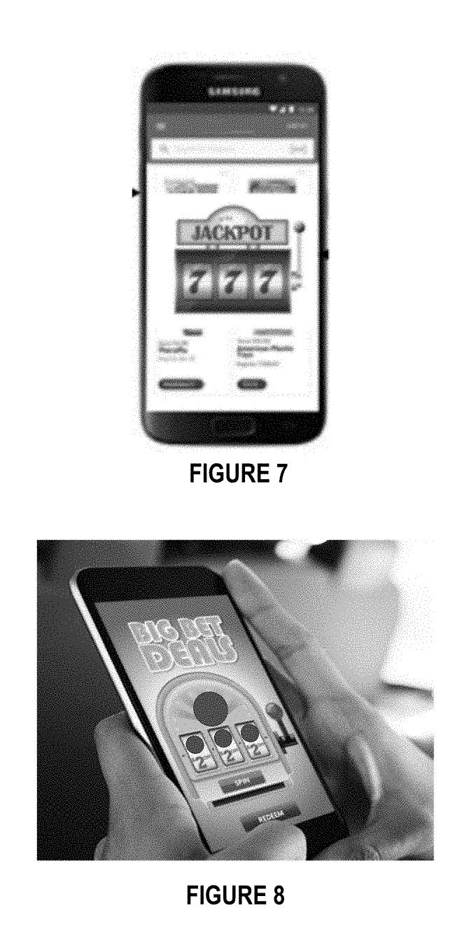

As shown in block 306, the mobile application is designed to allow the user to acquire an incentive using an interactive display, which is depicted in various representative embodiments in FIG. 7 and FIG. 8. The interactive display may take on various forms not shown in the Figures, but generally includes an interactive interface for the user to select an interactive element and initiate reaction of a virtual element on the display that indicates user eligible incentives. In some embodiments, the virtual element on the display is rotating virtual element designed to mimic a certain game, such as slot machine or spinning prize wheel. In other embodiments, the virtual element may be a different form of display for user-eligible incentives, such as a set of virtual playing cards, one or more boxes that the user may tap to open and reveal an incentive. It is understood that the virtual element on the display could take on a number of different forms not specifically described herein, but generally includes some interactive element which the user selects in order to prompt the display of a specific user-eligible incentive. It is understood that the game or activity presented using the virtual element to the user through the incentive management application 122 interface could be any number of interactive activities or virtual interactive displays and is not limited to a slot-machine style game. In some embodiments, the system may be configured to reward the user with the acquired incentive regardless of the outcome of the game or activity, or may otherwise scale the incentive acquired by the user based on the relative success that the user achieves within the game or activity. For instance, the user may match two-out-of-three slot windows on the slot-machine and subsequently receive a user-eligible incentive worth a certain value that is less than the maximum value possible of all the user-eligible incentives in the event of a three-out-of-three match. Additionally, the incentive awarded to the user may comprise additional “spins” or chances to interact with the game or activity through the incentive management application 122 interface. The user-eligible incentive displayed as a result of the user's interaction with the virtual element may be emphasized by the mobile application as an acquired incentive, and the acquired incentive may be animated or emphasized in some way as to indicate to the user that they have acquire the particular user-eligible incentive.

As shown in block 308, the incentive management system 106 may receive information from the mobile application that the user has successfully acquired the incentive. In some embodiments, the incentive management system 106 may have already determined and selected a user-eligible incentive that the user will acquire if they choose to interact with the virtual element of the mobile application. In other embodiments, the determination of the exact incentive that the user acquires through interacting with the mobile application may be determined by the mobile application and reported back to the incentive management system 106. In some embodiments, the incentive management system 106 may determine a specific set of user-eligible incentives that the mobile application may further narrow down to determine a specific acquired incentive.

Once the specific incentive that the user has acquired is determined, the incentive management system 106 may record the acquired incentive, as shown in block 310 wherein the acquired incentive is locally stored by the mobile device or remotely by the incentive management system 106. In some instances, the acquired incentive will be stored locally on the mobile device or user device 104, on which the mobile application is displayed. In other embodiments, the mobile application or incentive management system 106 may interact with user profile database 190 or digital wallet system 214 in order to store the acquired incentive. Access to the digital wallet system 214 may be integrated within the mobile application so that the user may access the acquired incentives and other information stored in the digital wallet system 214 via the mobile application. In some instances, the incentive management system 106 may communicate with an entity system 160, other system 180, auxiliary user device 170, or point of sale system 208 and indicate that the user has acquired the acquired incentive, in which case the acquired incentive may be automatically applied by the entity system 160, other system 180, auxiliary user device 170, or point of sale system 208 during an interaction with the user, such as a transaction or sale of goods. In still other embodiments, the incentive management system 106 may integrate information from the digital wallet system 214 and the user profile database 190 and display the integrated information via the mobile application. In any instance, the goal of storing the acquired incentive is to provide the user access to the acquired incentive at a later time after the acquisition, as shown by block 312.

After the system receives the request from the user, the process then proceeds to block 304 wherein the system generates a unique user profile for the user and stores the profile in a database such as the user profile database 190. Once generated, the user profile may be populated with various information about the user that the user may provide through the incentive management application or information from the point of sale system 208, such as details about a recent transaction that the user participated in.

Next, as shown in block 306, the system may identify the user's eligibility for possible incentives based on data from the user profile database 190 or a third party database 206. In doing so, the system utilizes the incentive relevancy engine 202 to analyze the user's profile information and other information known about the user to determine which offers may be most relevant to the user. The incentive relevancy engine may then provide the results of this analysis to the incentive management engine 210, at which point the incentive management engine 210 may then determine whether a user is eligible to receive the relevant offers or incentives. The incentive management engine may make this determination based on a number of factors such as the amount of time since the user was last given an incentive, the user's transaction history with the entity, the user's frequency of interaction with the system, the user's frequency of transactions with the entity, the user's location data, and any other data that the system may be configured to consider with respect to eligibility, such as data received from third parties related to the user.

Next, as shown in block 308, the system may transmit a notification to the incentive-eligible user via the incentive management application 122 on the user device 104 indicating an option for incentive acquisition by the user. In some embodiments, the system may present the user with a notification that they have earned a “spin” or some other option for acquiring an incentive via the incentive management application 122 wherein the user may interact with the incentive management application 122 to acquire incentives. In one embodiment, the “spin” may be a chance to participate in a slot-machine style game or activity wherein the user may win incentives based on the outcome of the game or activity.

As shown in block 310, the system may then receive from the user a request to interact with the system via the incentive management application 122 to acquire incentives. In some embodiments, this request may comprise the use of an available “spin” or credit through the activity in the incentive management application 122. In some embodiments, the system may be configured to award the user with an incentive regardless of the outcome of the game or activity, or may otherwise scale the incentive acquired by the user based on the relative success that the user achieves within the game or activity. For instance, the user may match two-out-of-three slot windows on the slot-machine and subsequently receive an incentive worth a certain value that is less than the maximum value possible in the event of a three-out-of-three match. Additionally, the incentive awarded to the user may comprise additional “spins” or chances to interact with the game or activity through the incentive application interface 122. It is understood that the game or activity presented to the user through the incentive management application interface could be any number of interactive activities and is not limited to a slot-machine style game.

Finally, as shown in block 312, the system may identify a user-specific incentive based on the result of the interactive request with the activity in the incentive management application 122 and apply the incentive to the user's profile for immediate or future user by the user. As previously stated, the term incentive may refer to a discount, offer, coupon, or promotion that may be used or redeemed at an entity, merchant or other third party location. In some embodiments, the incentive management engine 210 may store this information in the user profile database 190 so that the user may access the incentive at a later time through the incentive management application on their user device. In other embodiments, the system may recognize that a user's profile contains an acquired incentive that is applicable to a transaction occurring at the point of sale system 208, and may interact with the point of sale system 208 to automatically apply the incentive toward the transaction without any further action by the user. Furthermore, in some embodiments, the incentive may comprise some form of token or value that is stored in a digital wallet and is managed by the digital wallet system 214. In some embodiments, the acquired incentives may be displayed by the incentive management application 122 as a barcode, quick response (QR) code, or alphanumerical code displayed through the incentive management application 122 on the user device 104 or an auxiliary user device 170.

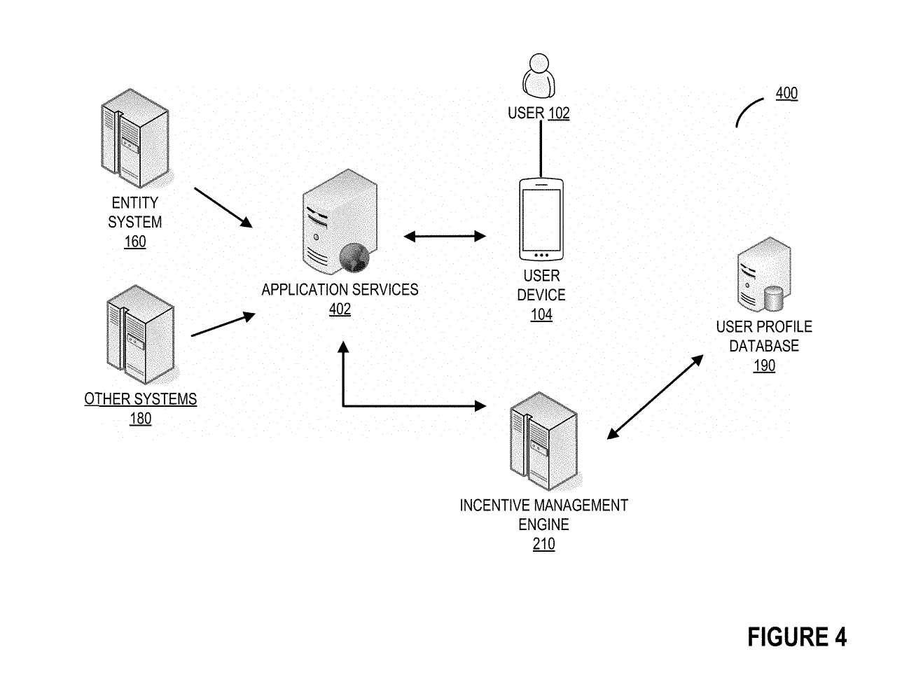

FIG. 4 depicts an interaction environment 400, in accordance with a further embodiment of the present invention, and is included to indicate the manner in which the incentive management engine 210, entity system 160, and other systems 180 communicate with the user device 104. As illustrated in FIG. 4, incentive management engine 210 is situated to receive user-related data from user profile database 190. User profile database 190 may contain user information such as terminal interface log data, incentive management application data, email data, past-acquired incentives and the like. In some embodiments, there may be multiple databases interacting with the incentive management engine 210. As shown, application services 402 is used to facilitate interaction between the user device 104 and incentive management engine 210, entity system 160, and other systems 180. Application services 402 can be provided by entity systems in some embodiments, while in other embodiments the application services 402 may be provided by a third party or cloud-based provider. As shown, application services 402 is situated to send and receive data to and from the user device 104. This data can be transmitted in a number of fashions, including by batch processing and by real-time streaming, and may include an application programming interface (API) designed to effectively communicate information between various systems and the inventive application interface 122 stored on the user device 104.

As data is collected by the application services 402, the data may trigger application services 402 to communicate with the user device 104 and incentive management engine 210 in a specific manner. In this way, the application services 402 can provide the user device with notifications that incentives are available based on recent purchase activity detected at the point of sale system 208 and based on eligibility determined by the incentive management engine, which may incorporate information from user profile database 190 in making this determination. The user 102 may then interact with the user device via the incentive management application 122 to acquire one or more incentives via application services 402 based on the result of the user's 102 interaction with the incentive management application 122. Once incentives are acquired by the user 102, the incentive management application 122 organizes the acquired incentives such that the user 102 can later access them.

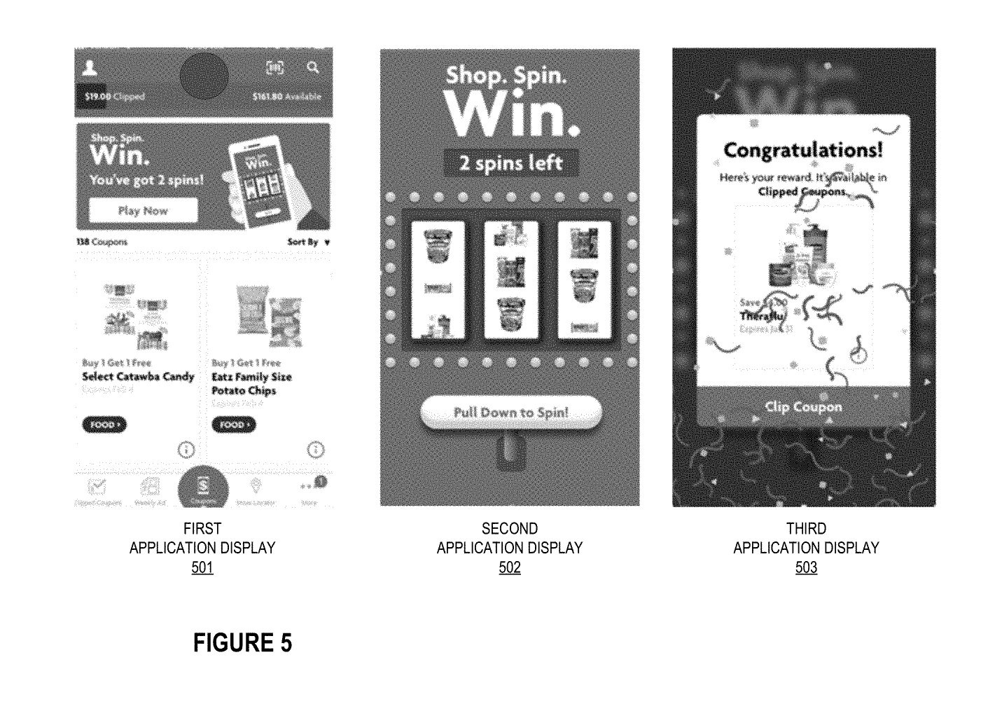

FIG. 5 depicts a representation of one embodiment of the present invention as implemented on a user device. As shown, the system may present the user with an incentive game or activity via the incentive management application 122 on the user device, wherein the user may interact with the incentive game or activity to acquire, manage, use and/or reference various incentives. It is understood that the incentive activity or game may comprise a number of other embodiments not depicted in FIG. 5.

Shown on FIG. 5 are three different displays within the incentive management application 122, labeled first application display 501, second application display 502, and third application display 503. As shown by the first application display 501, the incentive management application may include a home screen which may display various information about incentives, entity locations, user profile, and eligibility. The first application display 501 also includes a status bar at the top of the display area where an amount of acquired incentives is shown as compared to the total incentives available to be acquired by the user at a given time. In this embodiment, user 102 may tap the top right corner of the display to search and navigate among incentives for which the user 102 is eligible. Located next to the search icon is also a bar code scanner icon, which the user 102 may tap to activate the camera on the user device 104. The incentive management application 122 may receive data from the camera of the user device 104 and recognize physical incentives that may be stored and managed within the incentive management application 122 for later activation or use by the user 102. Additionally, the incentive management application 122 may, in some embodiments, use the information received from the camera of user device 104 to recognize a product barcode and search the database of user-eligible incentives related to that product. At the top left-hand corner, there is an icon that signifies the user settings. By tapping this icon, the user 102 may enter a user settings section within the incentive management application 122 where the user 102 can provide certain information related to their user profile, such as demographic information, product interests, preferences for notifications and the like.

Located just below the status bar on first application display 501 is a button labeled “play now,” as well as an indication that the user 102 has a number of “spins” available to them. In some embodiments, by tapping the “play now” button, the user enables second application display 502. As shown in second application display 502, the incentive management application may provide a display to simulate a slot machine style gameplay. In other embodiments, the incentive management application 122 may simulate a different type of gameplay, such as a spinning wheel with a variety of prizes, or some other virtual gameplay simulation. In the particular embodiment depicted in second application display 502, the user may “spin” the slot machine by swiping down on the lever at the bottom of the screen in order to initiate the slot machine gameplay. Depicted in the center of the display on second application display 502 are slot machine windows that animate to simulate the spinning of a slot machine following the downward swipe of the lever. If the slot windows indicate a matched line, the incentive management application may proceed to third application display 503, indicating a congratulatory message that the user 102 has acquired a specific incentive that they may choose to “clip,” or claim for storage.

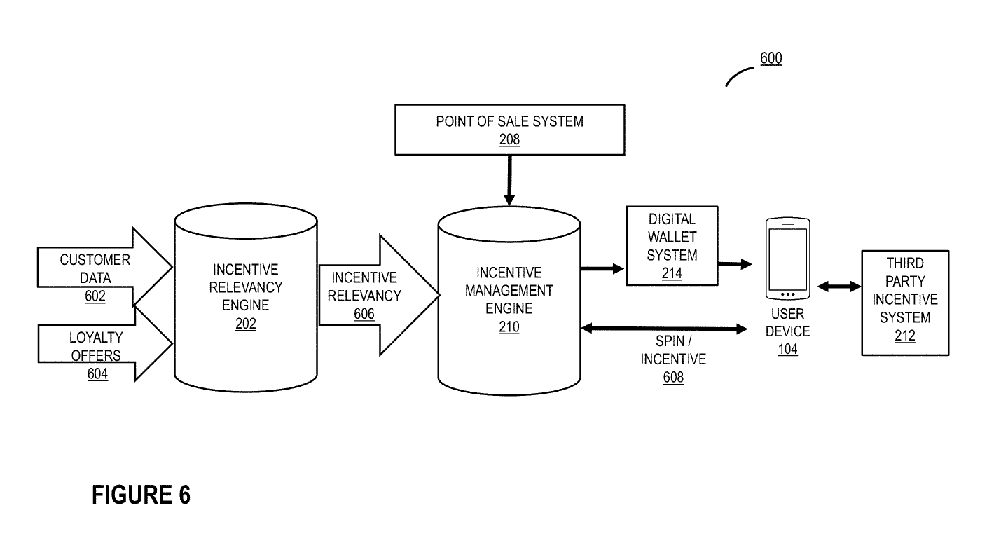

FIG. 6 depicts an incentive management platform with incentive relevancy engine and communication environment 600, in accordance with one embodiment of the present invention, and is provided as an example of how user data 602 and loyalty offers 604 may flow through the various systems and devices presented. As illustrated in FIG. 6, incentive relevancy engine 202 is situated to receive user data 602 and loyalty offers 604. In some embodiments, there may be multiple third party databases interacting with the incentive relevancy engine 202. The incentive relevancy engine 202 is designed to receive and process data from various sources to determine relevant incentives, offers, and content for each particular user or group of users that interacts with the incentive management system.

As further illustrated in FIG. 6, incentive management engine 210 is situated to receive incentive relevancy data 606 from incentive relevancy engine 202. In some embodiments, incentive relevancy engine 202 and incentive management engine 210 are both considered a part of the incentive management system 106. In some embodiments, the incentive management engine 210 is managed by the same entity that maintains the incentive management system 106 and/or incentive relevancy engine 202, while in other embodiments the incentive management engine 210 is managed by a third party entity. The incentive management engine is designed to interface with the point of sale system 208 such that various data about a current, past, or future transactions may be considered and utilized by the incentive management system 106. In this way, transaction data may be collected in real time from the entity and communicated to the user profile database 190, incentive relevancy engine 202, and may be reflected in information transmitted from the incentive management engine 210 to the user device 104. In some embodiments, the incentive management engine is responsible for transmitting data to the user device to update the information displayed to the user 102 through the incentive management application 122. Data from other sources may also be incorporated into the incentive management application 122, such as from a digital wallet system 214 or some other system, such as third party incentive system 212.

As further shown in FIG. 6, digital wallet system 214 may interact with the incentive management engine 210 and user device 104. In some embodiments, the digital wallet system 214 is managed by the same entity that maintains the incentive management system 106 and/or incentive relevancy engine 202, while in other embodiments the digital wallet system 214 is managed by a third party entity. Utilization of the digital wallet system 214 may be integrated within the incentive management application 122 and provide the utilization of various data such as payment credentials or tokens/aliases associated with a digital wallet, or account identifiers stored by a mobile application. In this way, the incentives generated by the incentive management system may integrate information provided by the digital wallet system 214. Furthermore, as shown in FIG. 6, communication environment 600 may also include third party incentive system 212. In some embodiments, the third party incentive system may be utilized by the entity in the production and management of incentives. For instance, in some embodiments, the user may be given an opportunity to claim incentive offers within the incentive management application 122, wherein the details and validity timeframe of the incentive offer might be managed by the third party incentive system 212. As shown, user device 104 may interact with incentive management engine 210 via a spin/incentive 608, wherein the user may indicate to the incentive management engine that it would like to participate in an interactive game, activity, virtual interaction or the like by selecting the “spin” option. In response to the user's “spin,” the incentive management engine 210 will determine whether the user should receive an incentive, and if so, will communicate the incentive directly to the user device or to the digital wallet system 214.

FIG. 7 and FIG. 8 each depict a representation of one possible embodiment of the present invention as implemented on a user device. As shown, the system may present the user with an incentive game or activity via the incentive management application 122 on the user device 104, wherein the user may interact with the incentive game or activity to acquire, manage, use and/or reference various incentives. It is understood that the incentive activity or game may comprise a number of other embodiments not depicted in FIG. 7 and FIG. 8.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions.

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A mobile device for providing an enhanced incentive management interface, the mobile device comprising:
at least one memory device with computer-readable program code stored thereon;
at least one communication device;
at least one display device;
at least one processing device operatively coupled to the at least one memory device, the at least one display device, and the at least one communication device, wherein executing the computer-readable program code is configured to cause the at least one processing device to:
receive notification information from an incentive management system, wherein the notification information indicates a user's eligibility to acquire an incentive;
display the notification information on the at least one display device;
receive, from the incentive management system, user-eligible incentives;
display a selectable interactive element on the at least one display device; and
in response to the user selecting the interactive element, display, on the at least one display device, an acquired incentive, wherein the acquired incentive is one of the user-eligible incentives.

2. The mobile device of claim 1, wherein executing the computer-readable program code is configured to cause the at least one processing device to display a virtual rotating element on the at least one display device, the virtual rotating element comprising a plurality of the user-eligible incentives, wherein the virtual rotating element is displayed prior to displaying the acquired incentive.

3. The mobile device of claim 2, wherein executing the computer-readable program code is configured to cause the at least one processing device to:
rotate the virtual rotating element in response to the user selecting the interactive element; and
stop rotating the virtual rotating element, wherein the acquired incentive is displayed once the virtual rotating element has stopped rotating.

4. The mobile device of claim 1, wherein the acquired incentive is at least partially randomly selected by the mobile device from the identified user-eligible incentives.

5. The mobile device of claim 1, wherein executing the computer-readable program code is configured to cause the at least one processing device to receive instructions from the incentive management system indicating which of the user-eligible incentives is the acquired incentive.

6. The mobile device of claim 1, wherein executing the computer-readable program code is configured to cause the at least one processing device to display the acquired incentive as a barcode, quick response (QR) code, or alphanumerical code.

7. The mobile device of claim 1, wherein executing the computer-readable program code is configured to cause the at least one processing device to store the acquired incentive locally on the at least one memory device, and display, on the at least one display device, a selectable option to display the acquired incentive, and, in response to receiving a selection of the selectable option, display, on the at least one display device, the acquired incentive.

8. The mobile device of claim 1, wherein executing the computer-readable program code is configured to cause the at least one processing device to:
transmit the acquired incentive to the incentive management system for storage;
receive a later request from the user to display the acquired incentive;
transmit a request to the incentive management system for the acquired incentive;
receive the acquired incentive from the incentive management system; and
display the acquired incentive.

9. The mobile device of claim 1, wherein executing the computer-readable program code is configured to cause the at least one processing device to:
receive a verification from the incentive management system that the user has completed a transaction;
wherein the notification information is displayed in response to receiving the verification from the incentive management system that the user has completed the transaction.

10. The mobile device of claim 1, wherein executing the computer-readable program code is configured to cause the at least one processing device to determine a location of the mobile device and transmit the location to the incentive management system.

11. An enhanced incentive management system, the system comprising:
at least one memory device with computer-readable program code stored thereon;
at least one communication device;
at least one processing device operatively coupled to the at least one memory device, and the at least one communication device, wherein executing the computer-readable code is configured to cause the at least one processing device to:
provide a mobile application to a mobile device of a user, wherein the mobile application is configured to cause the mobile device to:
receive notification information from the incentive management system for display on a mobile device;
display the notification information on the mobile device;
receive identified user eligible incentives;
display a selectable interactive element on the mobile device; and
based on the user selecting the interactive element, display an acquired incentive, wherein the acquired incentive is one of the user-eligible incentives;
receive a request from the user to enroll in the incentive management system;
receive user profile information from the user;
generate and store a user profile containing the user profile information;
based on the user profile information, identify user-eligible incentives; and
generate and transmit, to the mobile device, the notification information, wherein the notification information indicates an option for the user to acquire one of the user-eligible incentives.

12. The system of claim 11, wherein executing the computer-readable code is configured to cause the at least one processing device to:
receive a request from the mobile device for details of the acquired incentive; and
transmit, to the mobile device, details of the acquired incentive as a barcode, quick response (QR) code, or alphanumerical code.

13. The system of claim 11, wherein executing the computer-readable code is configured to cause the at least one processing device to:
at least partially randomly select an acquired incentive from the user-eligible incentives;
store the acquired incentive in the user profile; and
transmit the acquired incentive to the mobile device.

14. The system of claim 11, wherein executing the computer-readable code is configured to cause the at least one processing device to receive, from the mobile device, the acquired incentive selected by the mobile device and store the acquired incentive in the user profile.

15. The system of claim 11, wherein the identified user-eligible incentives are generated based on weighted user profile information.

16. The system of claim 11, wherein the provided mobile application is configured to cause the mobile device to determine a location of the mobile device and transmit the determined location to the incentive management system.

17. The system of claim 16, wherein executing the computer-readable code is configured to cause the at least one processing device to:
receive the determined location from the mobile device; and
analyze the determined location and determine that the mobile device's location is proximate to an entity location;
wherein the notification information is transmitted to the mobile device in response to determining that the mobile device's location is proximate the entity location.

18. The system of claim 11, wherein executing the computer-readable code is configured to cause the at least one processing device to:
receive additional user profile information; and
based on the additional user profile information, alter the user-eligible incentives based on the additional user profile information.

19. The system of claim 11, wherein executing the computer-readable code is configured to cause the at least one processing device to:
receive third party incentives from a third party incentive management system; and
incorporate the third party incentives in the identified incentives that the user is eligible to acquire.

20. A computer-implemented method for managing and providing incentives to a user, the method comprising:
providing a mobile application to a mobile device of a user, wherein the mobile application is configured to cause the mobile device to:
receive notification information from the incentive management system for display on a mobile device;
display the notification information on the mobile device;
receive identified user eligible incentives;
display a selectable interactive element on the mobile device; and
based on the user selecting the interactive element, display an acquired incentive, wherein the acquired incentive is one of the user-eligible incentives;
receiving a request from the user to enroll in the incentive management system;
receiving user profile information from the user;
generating and storing a user profile containing the user profile information;
based on the user profile information, identifying user-eligible incentives; and
generating and transmitting, to the mobile device, the notification information, wherein the notification information indicates an option for the user to acquire one of the user-eligible incentives.
